(19) United States
(12) Patent Application Publication
(10) Pub. No.: US 2004/0059636 A1
(43) Pub. Date: Mar. 25, 2004

(54) Method and process of providing a variety of services to a customer through a single source

(75) Inventors: William J. McClung, Naperville, IL (US); Scott M. Oleson, Aurora, IL (US); John R. Western, Wheaton, IL (US); John P. Morine, Naperville, IL (US); Victoria A. Gollwitzer, Wheaton, IL (US); Renee C. DeBoor, Geneva, IL (US)

Correspondence Address: Marshall J. Brown, Foley & Lardner, One IBM Plaza, Suite 3300, 330 North Wabash Avenue, Chicago, IL, 60611-3608, US

(73) Assignee: Administrative Resources Options

(21) Appl. No.: 10/255,872

(22) Filed: Sep. 25, 2002

(51) Int. Cl. G06F 17/60

(52) U.S. Cl. 705/26

(57) ABSTRACT

A system and method in accordance with the principles of the present invention provides a web-based user interface for providing customers with access to a full range of business services tailored to their specific needs. The system includes the ability to request business services. Additionally, information about the provided services may be quickly accumulated and organized to aid the provider and the customer in a variety of ways. For example, the customer is provided with the ability to analyze and track the frequency certain services are provided, the quality of the services, and the costs of the services over particular time frames. The provider is also given the ability to analyze the service information to determine if certain customer quality standards are being met. Customer management is also provided with the ability to control and monitor access to certain features by its employees, along with the ability to generate and view exception reports regarding certain activities.

### FIELD OF THE INVENTION

This invention relates to a system and method for providing a variety of different office services to individual users from a single source.

### BACKGROUND OF THE INVENTION

In today's ever changing business world, individual corporations rely upon a number of outside sources to have even the most basic of tasks completed. For example, a single company may use three or more different companies for courier services around the world. The same company also may rely upon one or more local couriers to deliver packages inside an individual city. Internally, companies, firms, and other organizations often use third parties to perform services such as for example copying, hospitality services, travel services, and facilities management. Given today's ultracompetitive business environment, it is of the utmost importance that all of these services be provided as efficiently and economically as possible.

A number of companies currently provide several of these services to business entities. For example, some “provider” companies provide copying and faxing services, supply office products to individual employees, work with outside courier and messenger services for the delivery of packages, and other functions. By having a single company perform and/or facilitate multiple services, the “customer” company or firm can reduce the number of entities with which it has to deal on a daily basis, increasing efficiency and decreasing costs.

Although the services provided by provider companies are beneficial to the particular customer, the manner in which individual services are provided include a number of limitations. For example, when an individual customer requests that a copying job be completed, the user typically fills out a piece of paper and either hand delivers that paper to a provider or drops it off in a pick-up box. The paper is then subsequently transferred to the copying center where the individual job is completed. Similar mechanisms are used for providing courier services, requesting hospitality services such as meals and drinks, and other services. Not surprisingly, in a company or firm that has hundreds or even thousands of employees, the amount of paper that is generated for these activities has become very cumbersome. Furthermore, the constant transfer of work orders can result in individual orders being lost, misdirected or misplaced. The simple process of filling out a piece of paper every time a job is requested also adds to the overall burden of both the customer and the provider.

Even more problems arise when it becomes time to analyze the overall efficiency and financial condition of the customer. For example, it would often be beneficial for the customer to be able to determine how often certain types of services are requested and the costs for services provided. Additionally, the company may want to determine if the provider is performing its services in a satisfactory manner. Although some providers have paper forms that may be filled out to evaluate the provider's performance, employees of the customer often do not fill out these forms, particularly with the large volume of paper that shuffles through an office on a particular day. Furthermore, the company may want to keep track of certain services in order to monitor abuse by its employees. For example, cost conscious companies and firms may be particularly concerned if office supplies are consistently being ordered at certain times of the year (for example, the beginning of the school year) and used for nonbusiness purposes. In cases where an employer is particularly cost-conscious about such products, it will be beneficial for the company to have a system that would prevent certain employees from using the services at particular times.

In the case of courier services, individual customer-employees may also not be aware of the variety of options available to them. For example, if the employee's company or firm has the ability to use six or seven different courier services, then an employee's lack of information about competitive rates and shipping times could result in an increase in cost to the employer.

Moreover, individual employees often cannot determine the status of a particular job request. This can become a major issue if, for example, a particular copying job is being delayed even though a deadline is quickly approaching.

For all of these reasons, it would be desirable to develop an efficient system that allows individual employees to request a variety of services in a quick, efficient and paperless manner. It would be desirable to develop an efficient system that allows employees to determine the status of a particular job request. It would also be desirable to develop a system that can accumulate data concerning the different services that are requested by the employees so that the company can monitor the cost being incurred, the quality of the services provided and other features.

### SUMMARY OF THE INVENTION

A system and method in accordance with the principles of the present invention efficiently allows individual employees to request a variety of services in a quick, efficient and paperless manner. A system and method in accordance with the principles of the present invention efficiently allows employees to determine the status of a particular job request. A system and method in accordance with the principles of the present invention efficiently can accumulate data concerning the different services that are requested by the employees so that the company can monitor the cost being incurred, the quality of the services provided and other features.

A system and method in accordance with the principles of the present invention provides a web-based user interface for providing customers with access to a full range of business services tailored to their specific needs. The specific services available to customers may vary depending upon whether the particular customer is an outsourcing customer (where the provider does not normally operated on the customer's premises) or a business service client (where the provider operates on the customer's premises). Additionally, information about the provided services may be quickly accumulated and organized to aid the provider and the customer in a variety of ways. For example, the customer is provided with the ability to analyze and track the frequency certain services are provided, the quality of the services, and the costs of the services over particular time frames. The provider is also given the ability to analyze the service information to determine if certain customer quality standards are being met.

### BRIEF DESCRIPTION OF THE DRAWINGS

FIG. 1 is a diagram showing a sample system used by a provider and customer according to one embodiment in accordance with the principles of the present invention.

FIG. 2 is a screen display of user's desktop including an icon for executing a system and method in accordance with the principles of the present invention.

FIG. 3 is a screen display of a user login screen for a system and method in accordance with the principles of the present invention.

FIG. 4 is a screen display showing the services that are available to a non-management user according to one embodiment in accordance with the principles of the present invention.

FIG. 5 is a screen display showing the services and tools (?) available to a management user according to one embodiment in accordance with the principles of the present invention.

FIG. 6 is a screen display that permits a user to request an overnight courier service according to one embodiment in accordance with the principles of the present invention.

FIG. 7 is a screen display showing a printable courier tracking slip according to one embodiment in accordance with the principles of the present invention.

FIG. 8 is a screen display showing an office supply order form according to one embodiment in accordance with the principles of the present invention.

FIG. 9 is a screen display showing the status of a sample of tasks requested by an individual user according to one embodiment in accordance with the principles of the present invention.

FIG. 10 is a screen display showing an alert that an exception report has been generated by a user according to one embodiment in accordance with the principles of the present invention.

FIG. 11 is a screen display showing a listing of exception reports generated by various users according to one embodiment in accordance with the principles of the present invention.

FIG. 12 is a system access screen display according to one embodiment in accordance with the principles of the present invention where a manager can provide proactive control over budgetary spending.

FIG. 13 is a system access screen display according to one embodiment in accordance with the principles of the present invention where a manager can suspend the ability of certain users to perform certain functions.

FIG. 14 is a report management system display according to one embodiment in accordance with the principles of the present invention where a manager can track various pieces of information concerning services that have been requested during a specified time frame.

FIG. 15 is a report management system display according to one embodiment in accordance with the principles of the present invention showing a log of a certain type of courier service for a particular user.

FIG. 16 is a screen display showing the types of quality information which can be retrieved about previous job requests according to one embodiment in accordance with the principles of the present invention.

FIG. 17 is a screen display showing statistical information about the quality of previous jobs according to one embodiment in accordance with the principles of the present invention.

FIG. 18 is a screen display showing how a user can access information about provider productivity over a particular time period according to one embodiment in accordance with the principles of the present invention.

FIG. 19 is a screen display outlining provider productivity information on various jobs over a particular time period according to one embodiment in accordance with the principles of the present invention.

FIG. 20 is a flow diagram showing how a new account is created according to one embodiment of the invention.

FIG. 21 is a flow diagram showing the manner in which existing account information can be modified according to one embodiment of the invention.

FIG. 22 is a flow diagram showing how print/bindery services are processed according to one embodiment of the invention.

FIG. 23 is a flow diagram showing how mail services are processed according to one embodiment of the invention.

FIG. 24 is a flow diagram showing how facsimile services are processed according to one embodiment of the invention.

FIG. 25 is a flow diagram showing how a typical job request for courier services is processed according to one embodiment of the invention.

FIG. 26 is a flow diagram showing how a typical job request is routed from a customer employee to a central Service Center according to one embodiment of the invention.

### DETAILED DESCRIPTION OF THE INVENTION

The present invention comprises a system and method integrating the various functions that are performed by provider companies (“providers”) to customer companies or firms (“customers”). In a preferred embodiment in accordance with the principles of the present invention, the individual employees of the customer possess the ability to order, track and provide feedback on number of different individual tasks (“job requests”) for the customer in various areas such as (for example) copying, faxing, courier services, messenger services, and hospitality services. Job request information is transmitted through a local area network or wide area network directly to the provider, who can then process the individual job requests and enter information concerning the level of completion of a job request and any outstanding issues which may arise. Management personnel for the customer (“customer management”) is provided access to statistical and quality information concerning individual job requests that have been submitted and completed; likewise, the provider management personnel are provided access to similar information, giving both the provider and the customer valuable information regarding the efficiency of the provider services and the customer's job requests. A system and method in accordance with the principles of the present invention provide both the customer and the provider with the ability to reduce or eliminate paper transactions, potentially reducing the incidence of problems in the completion of job requests.

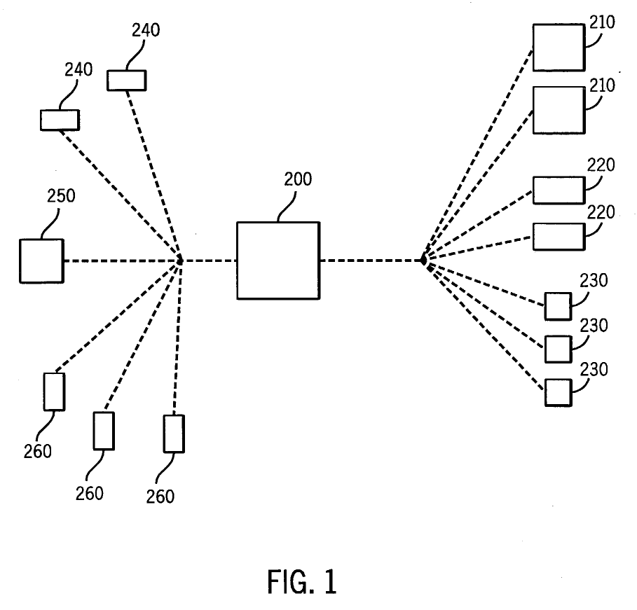

In one embodiment in accordance with the principles of the present invention as shown in FIG. 1, all the information regarding customer job requests is routed through one or more servers 200. On the customer's side, any employee which may have the need to order particular services can have a program installed on their desktop computer 210, laptop computer 220, wireless device 230, personal digital assistant or other computerized system. Job requests can be requested by a customer employee for any of the services provided. Upon opening the program, the customer employee has the ability to choose from the types of services that are available, obtain cost estimates for particular job requests, enter specific job requests and monitor the status of job requests that have already been made. After the job request has been completed, the customer employee also has the ability to provide feedback and/or file complaints about the job requests that have been completed. The customer's management may also obtain this information from his or her own computerized device, but also has the ability to oversee various administrative functions. For example, the customer's management can observe the frequency of which certain services are provided, the customer employee's satisfaction level with individual job requests, the costs associated with the provider services and other features.

Depending upon the particular structure of the provider, the provider's employees also have the ability to access the system directly or indirectly through their own laptop computers 240, desktop computers 250, wireless devices 260, personal digital assistant or other computerized system. For example, provider employees that are responsible for copying services may have a desktop terminal in the copying center through which they can obtain information about recent job requests. Hospitality personnel on the other hand, may possess wireless devices such as a personal digital assistant, such that they can retrieve and process orders from a remote location. The provider employees also have the ability to enter data regarding whether individual job requests have been completed, the reasons for certain delays that may occur and any additional comments that may be necessary. Provider management has the ability to access all of this information as well, in addition to monitoring the performance of the provider employees and obtain valuable feedback concerning the quality of the services that are being provided.

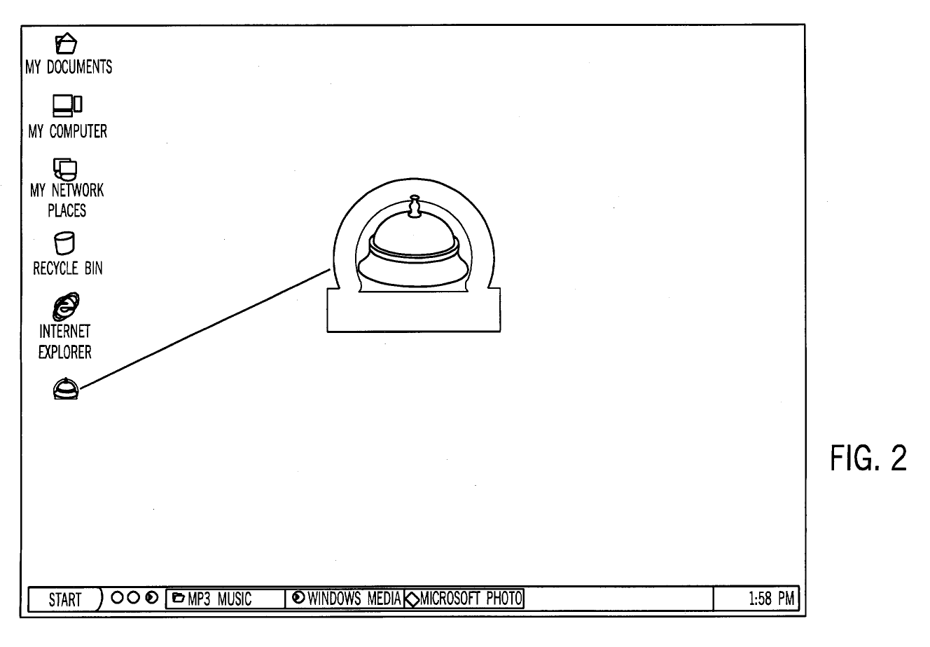

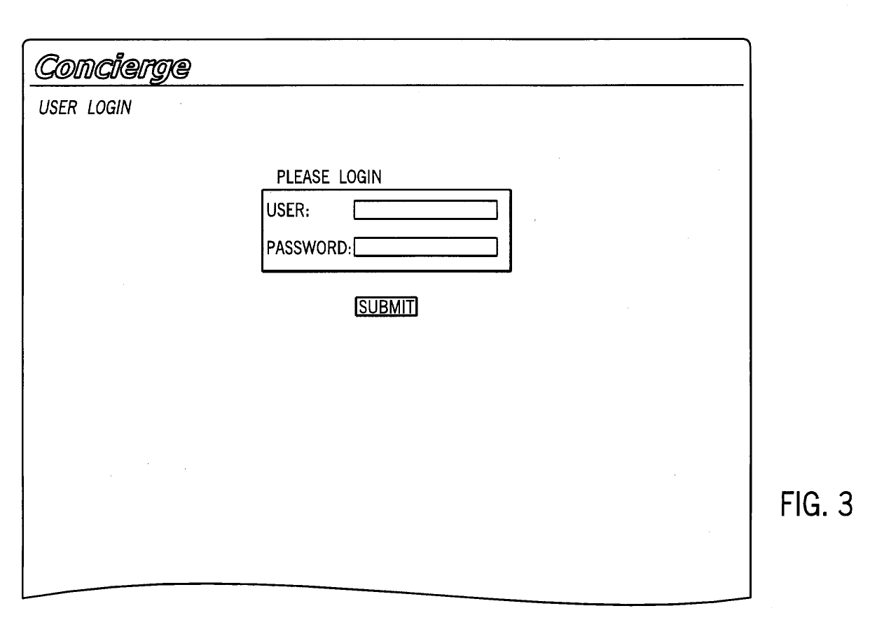

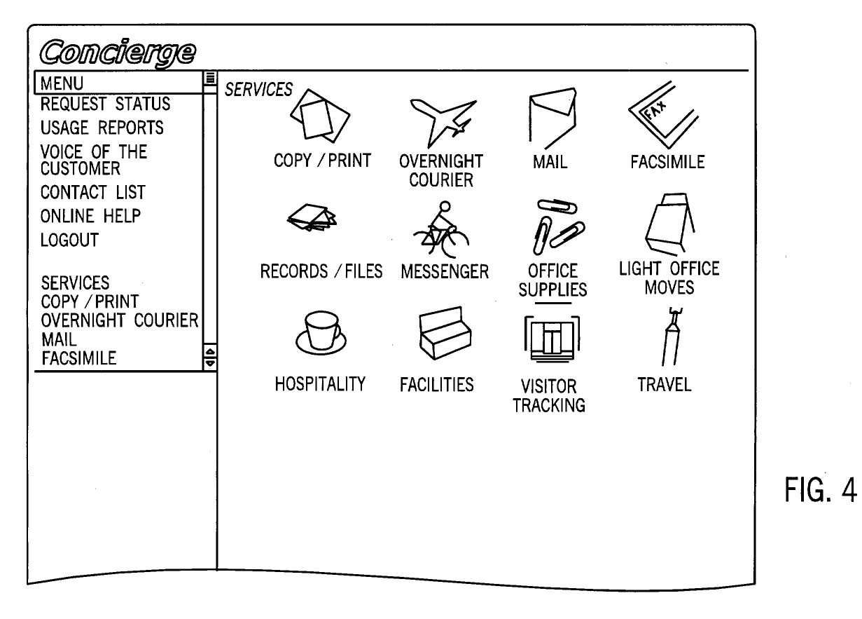

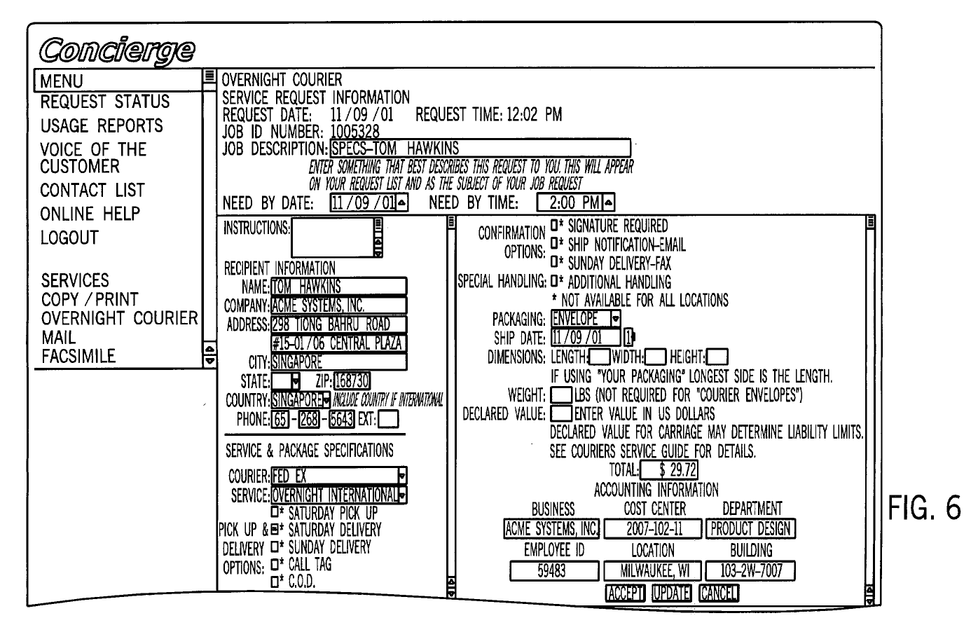

Referring now to FIGS. 2-19, a graphical user interface according to one embodiment in accordance with the principles of the present invention is seen. In this embodiment, an icon 12 for the program appears on the customer employee's desktop, as shown in FIG. 2. Upon opening this program, the customer employee passes through a user login screen, shown in FIG. 3, where a customer employee enters his own user name and password. The system will then load the customer employee's accounting information, such as the customer employee's name, the work location, employee number, and other information included under the heading “Accounting Information” in FIG. 6. Depending on the user name and password, the system determines the status of the user as for example a employee or manager, which subsequently determines the information to which the user can gain access. Upon the acceptance of the password, the customer employee is brought to a “services” screen, shown in FIG. 4. The services screen provides the user with all the different types of services which may be requested from the user's desktop. In this particular embodiment of the invention, copying/printing services, mail services, overnight courier services, facsimile services, messenger services, office supply services, light office moving services, hospitality services, facilities services, visitor tracking services, travel services and record maintenance services can all be accessed and/or requested by the customer employee.

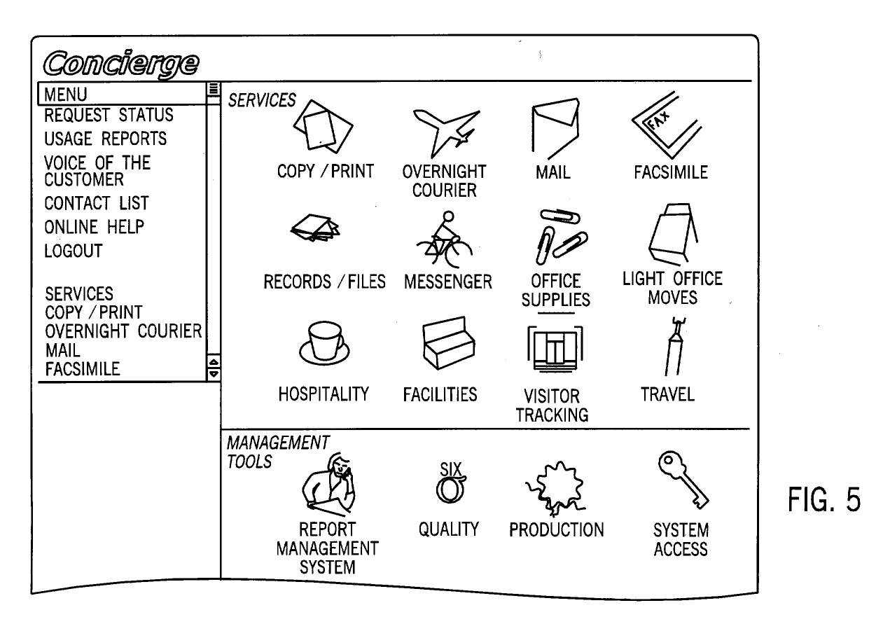

In the case of customer management, the manager will have additional tools available to her. In the example shown in FIG. 5, the manager can access a report management system, monitor the quality of the services provided, examine production data and control system access.

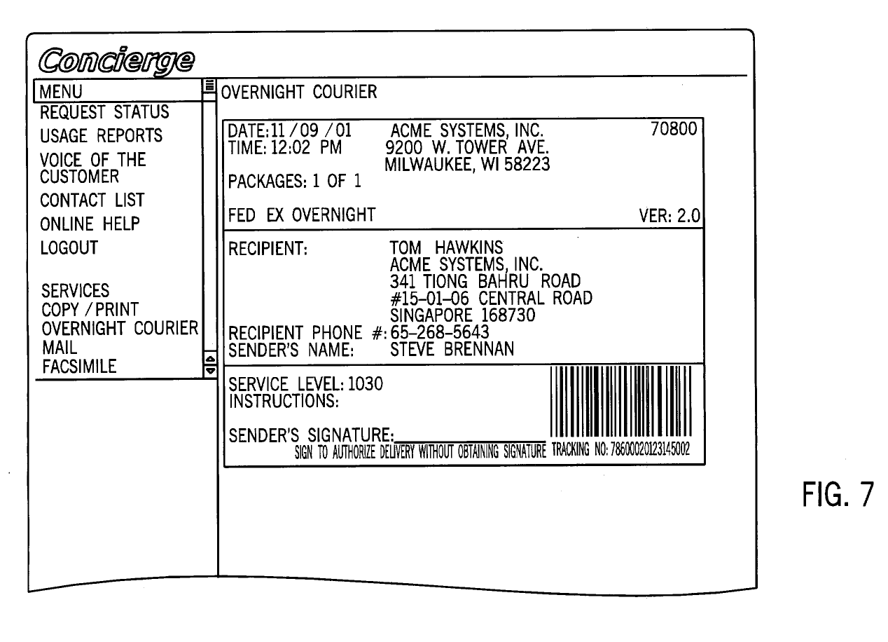

FIG. 6 shows an example of overnight courier services that may be requested by a customer employee. In FIG. 6, the user has the ability to input all the information needed to request overnight courier services. Alternatively, the system may be capable of adding and inputting the recipient information from an associated address book. In addition to entering a job description and recipient information, the customer employee can enter the precise service to be provided (such as, overnight international, second day air, etc.) and has the ability to choose the courier to perform the service. The customer employee also has the ability to designate particular pick-up and delivery options, enter a specific ship date, designate the package size, and enter the appropriate accounting information. In one embodiment of the invention, the user may also have access to pricing information for different couriers and/or services. This gives the customer employee the added ability to monitor the costs incurred by having easy access to a wide variety of cost options. After completing the order form, a package label can be made for printing, including all the required information. This is shown in FIG. 7.

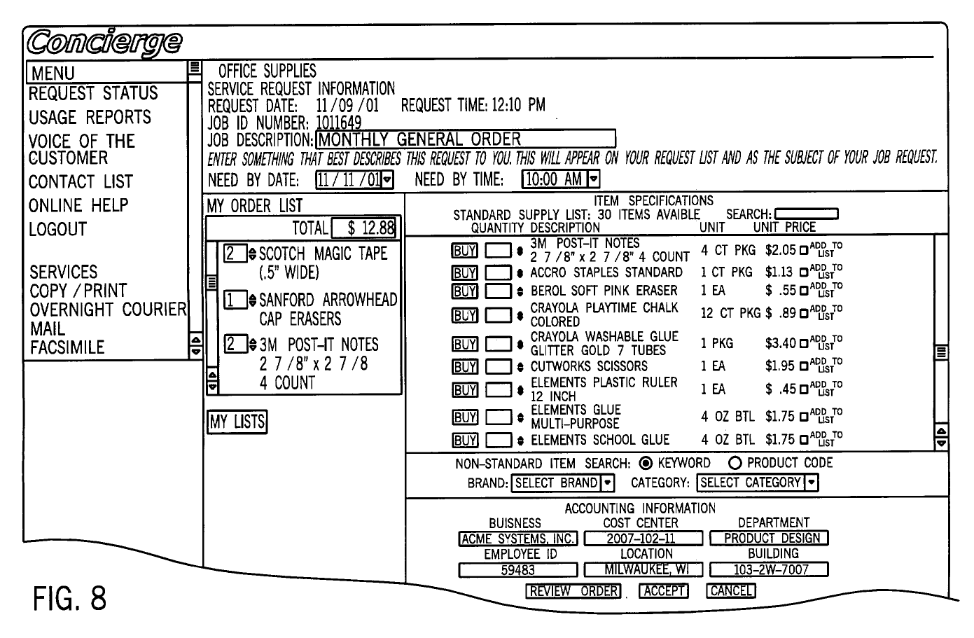

In the event that the customer employee desires to order office supplies, the screen shown in FIG. 8 provides the user with a variety of information to complete such an order. The information in FIG. 8 includes description of the items available, the different brand names available, categories of products available and pricing information. Thus, the customer employee is capable of ordering any available office supplies directly from her own computer. Upon completing the order form, the order form is electronically transmitted directly to the provider who can then deliver the requested office supplies to the customer employee.

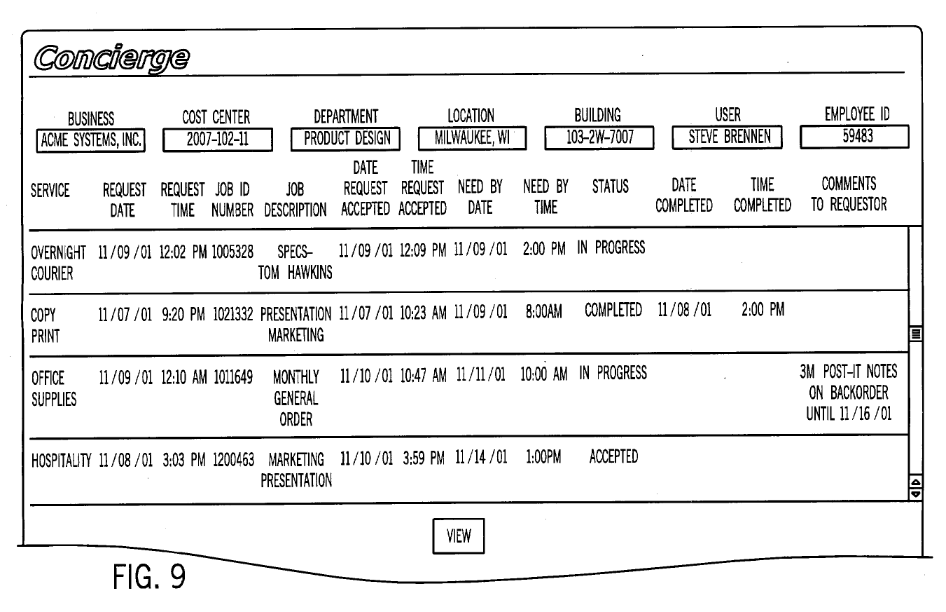

Regardless of the types of services that are provided, the customer employee is also able to instantly obtain information about job requests that have previously been made. As shown in FIG. 9, the system of the present invention is able to compile a report detailing each of the job requests made by the customer employee. For example, the status screen in FIG. 9 displays the type of services that have been requested, the date and time which the services were requested, a description of the particular job, the status of the job and other information. In the event that the provider needs to communicate certain information to the customer employee, this information will also be provided on the status screen. For example, one of the jobs in FIG. 9 includes an indication that certain office supplies are on back order until a future date.

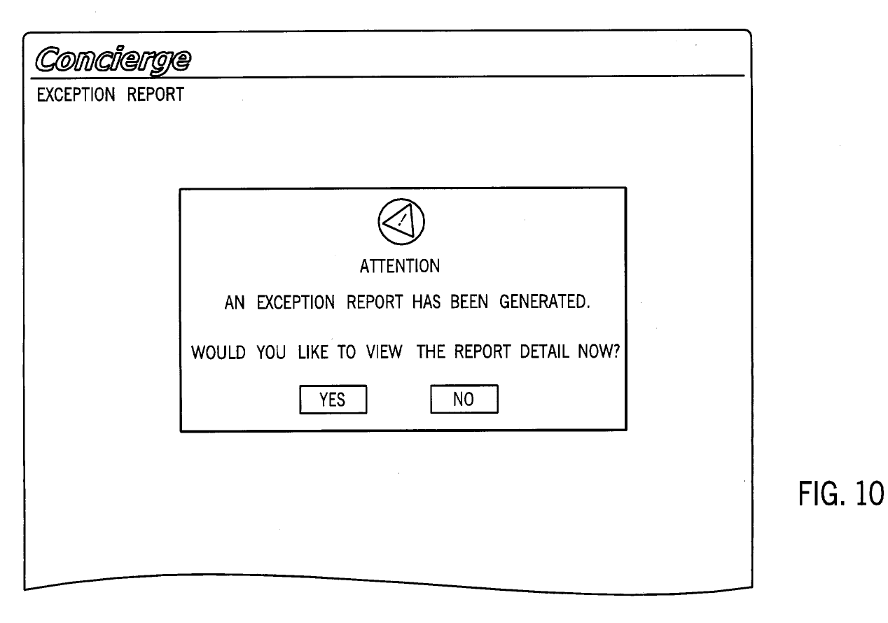

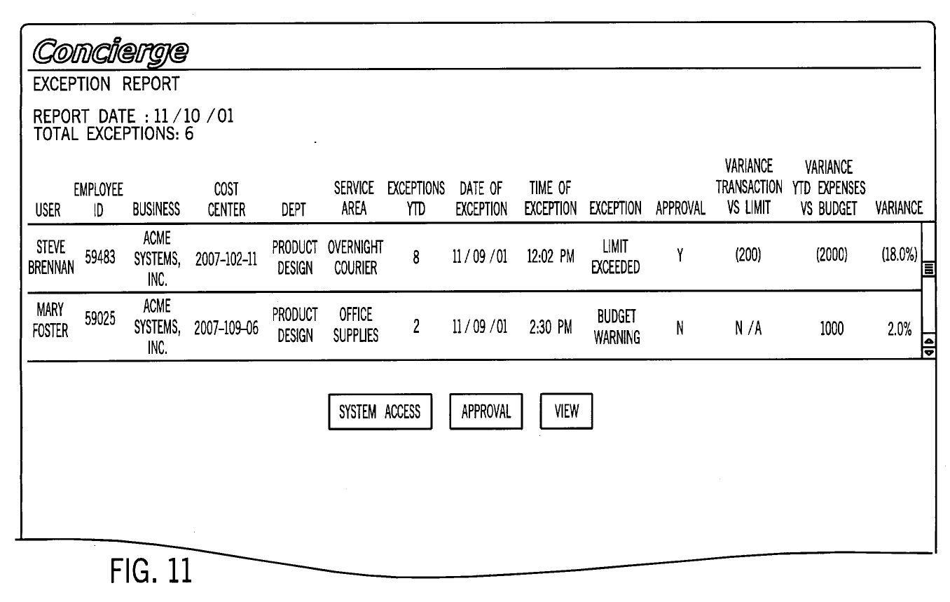

One of the advantages of the present invention is that it provides customer management with the ability to set individual spending limits and other cost containment parameters inside the software itself. For example, customer management can set a specific dollar figure beyond which certain customer employees cannot exceed when requesting services. Alternatively, the system can be arranged such that an exception report is generated whenever certain cost containment figures are exceeded. Customer management personnel can then be notified through an alert on their system, shown in FIG. 10, that provides them with direct access to these exception reports. An example of the exception reports that can be generated is shown in FIG. 11. These exception reports can provide information such as whether an individual customer employee is approaching or is past her own budgetary limit or whether an individual customer employee has generated an excessive number of “exception reports” during a specific time frame, with an exception report indicating that a user is requesting a service of which the management desires to be made aware. In one embodiment of the invention, exception reports can be generated on a daily basis. If customer manager clicks the “system access” button, the manager is given the ability to access the system controls for a particular user approve or view the details of a particular transaction and perform other features directly from the exception report screen.

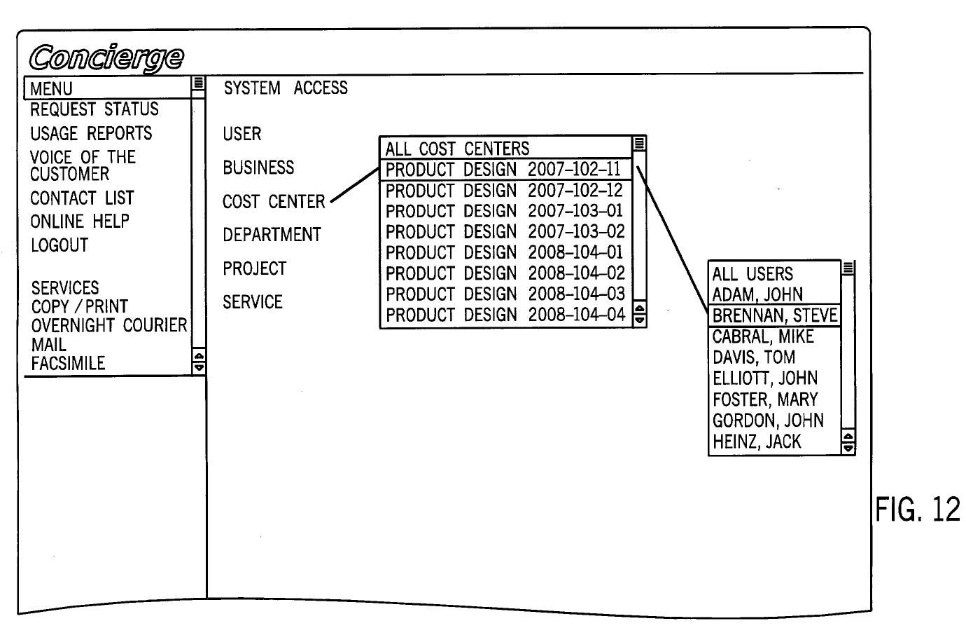

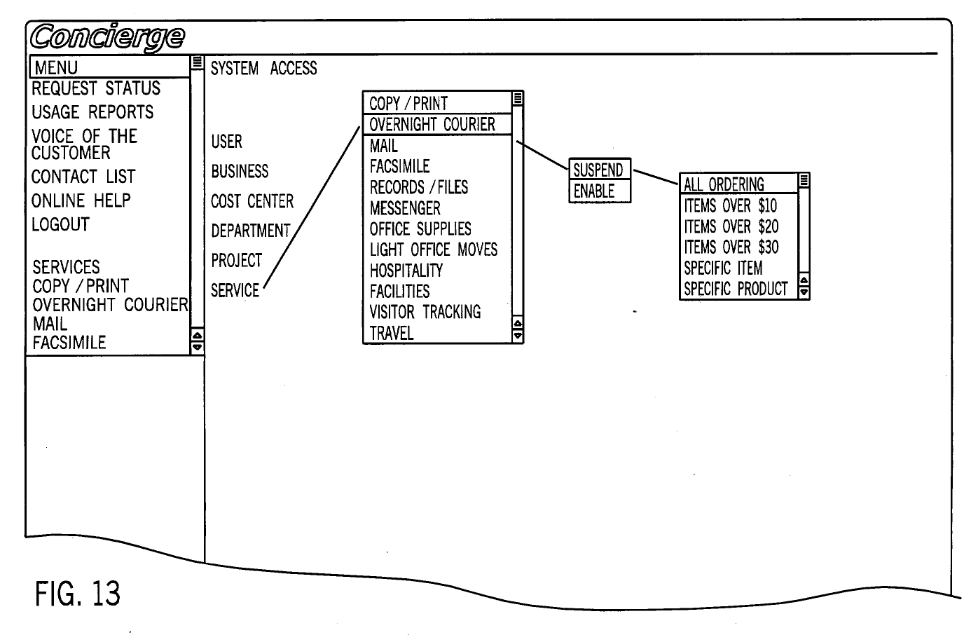

Customer management can also manipulate a “cost center” function in order to maintain proactive control over budgetary spending both for particular employees and particular groups. In particular, managers can be given the option of choosing what spending should occur or what types of spending should be restricted based upon trends or user activity. The screen shown in FIGS. 12-14 can be used for implementing these functions. For example, a number of business entities might experience a significant surge in the purchase of office supplies during the certain times of the year. In order to conserve costs and resources and reduce inventory over such a time period, a customer manager may desire to suspend orders for office supplies during “high use” periods or to eliminate excess inventory. As shown in FIG. 13, the customer manager has the ability to suspend or enable certain types of ordering for various services. For example, customer management may desire to suspend all overnight courier services that exceed ten, twenty or thirty dollars in price, or suspend the availability of a specific item, product or service.

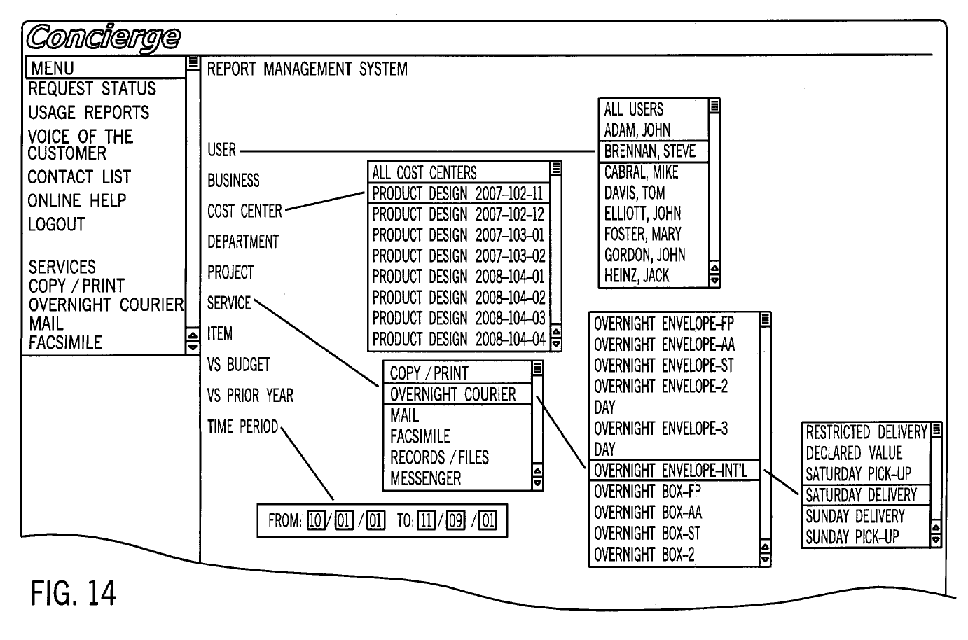

As represented in FIG. 14, once individual job requests are entered, the system will store all relevant data regarding the job requests, both individually and collectively. This provides customer management with the ability to access individual and collective data in order to manage spending, monitor trends in service activity and forecast future budgets. This also provides customer management with the ability to sort and generate reports on all available data fields or selected data fields.

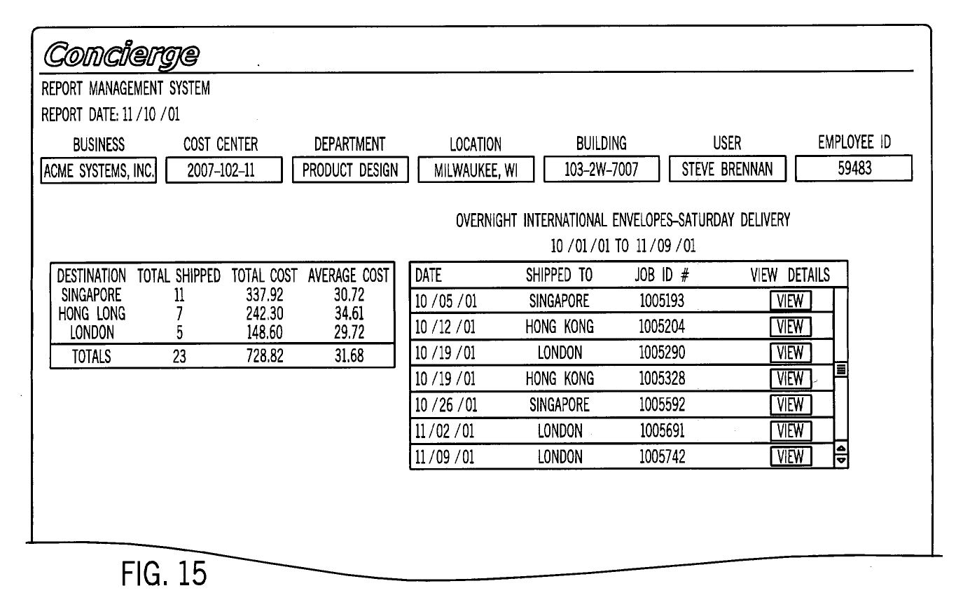

As shown in FIG. 15, the system also provides customer management with the ability to observe real time, onscreen reports about the services that are being provided. The customer manager also has the ability to focus on certain types of services that are being provided. For example, FIG. 15 shows all of the overnight international envelopes that have been sent via courier for Saturday delivery over a specified time frame. The customer manager has the ability to filter this information by client, department, location, building, user or other mechanism.

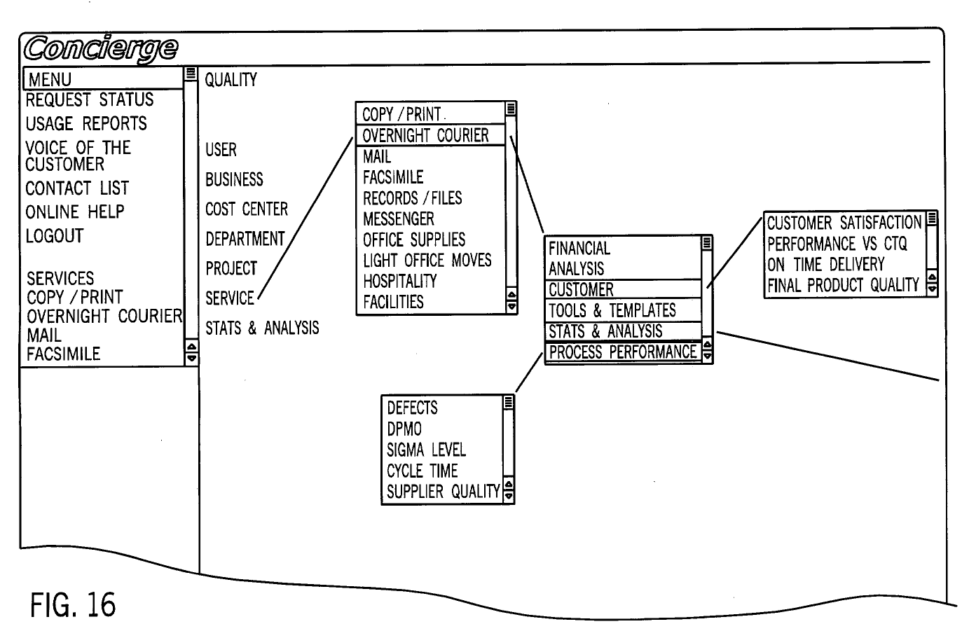

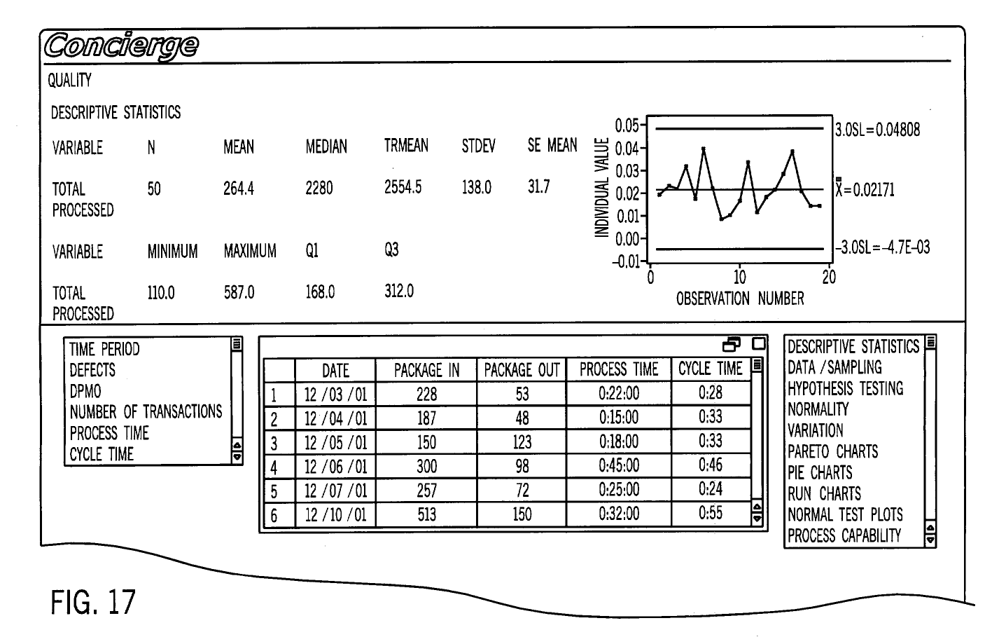

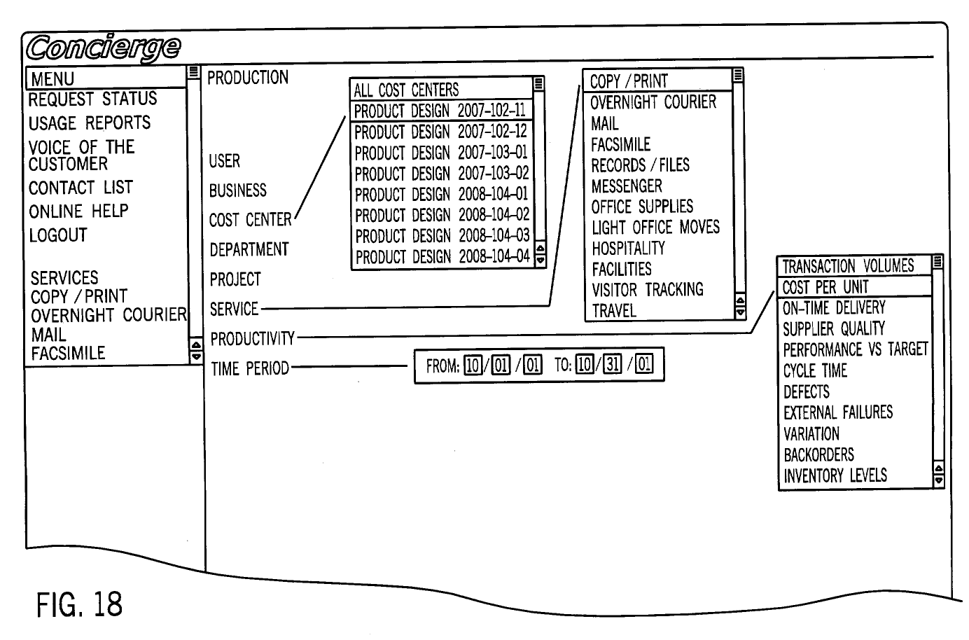

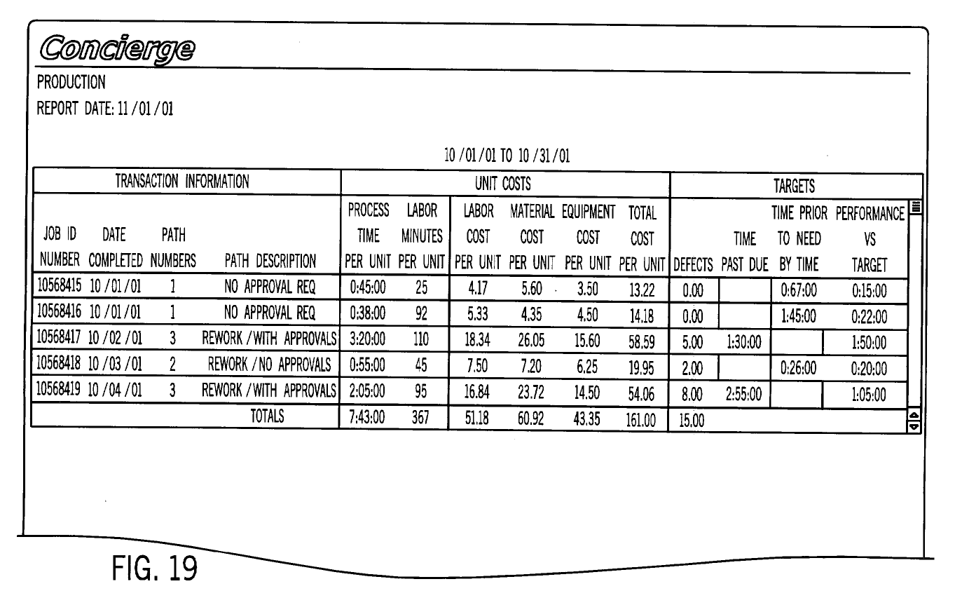

As shown in FIG. 16, the system of the present invention provides the customer with the ability to analyze the services provided in several manners, including the reporting of defects, on-time performance issues, overall customer satisfaction, process performance and other aspects. For example, in FIG. 17 data regarding the provided services can be processed to provide graphs and analysis data regarding the quality of the services. Productivity information, such as cost per unit of services provided, can also be analyzed, as shown in FIG. 18. FIG. 19 shows a mechanism where the customer can receive instant access to information and flexible reporting regarding different characteristics of individual job requests. This provides the customer and the provider with the ability to improve process efficiency, solve service problems before they happen, and realize where costs are being spent relative to the value that is being added by the services.

By having all of the data available for quick and immediate compilation, both the customer and the provider receive a number of clear benefits, including the potential to reduce head count and overhead expenses, an increased level of control in the proactive monitoring of employee spending, tools for analyzing and improving services that are provided, the ability to track and measure provider and customer productivity, and the ability to filter data and create customized reports at a moment's notice. All of these benefits are in addition to the ability to have a single location through which a variety of concierge services can be provided to a customer.

The following is a more detailed description of one implementation of the invention.

### EXAMPLE

Account Creation and Maintenance

Existing Customers can access the party's business services by visiting their website and choosing “Customer Login” on the main page. A secure login page is then displayed which requires the customer to enter a user name and password. Upon successful login, the customer is presented with a list of services that is available to them. Service availability would be dependent upon whether the customer is a Business Services customer or an Outsourcing Customer. Outsourcing Customers would be able to only access the services for which they have authorization. In the case where a user forgets their password, they will be able to enter their e-mail address and request that it be e-mailed to them.

In one embodiment of the invention, a present customer could create a new account by pressing the “Customer Login” button on the main web page for the website. Users who press the “Customer Login” button on the main web page are directed to a Login page where they have the choice of logging in, creating a new account, modifying an existing account, or touring the available basic services. In an alternate embodiment of the invention, only the system administrator or other provider personnel is capable of creating a new login account.

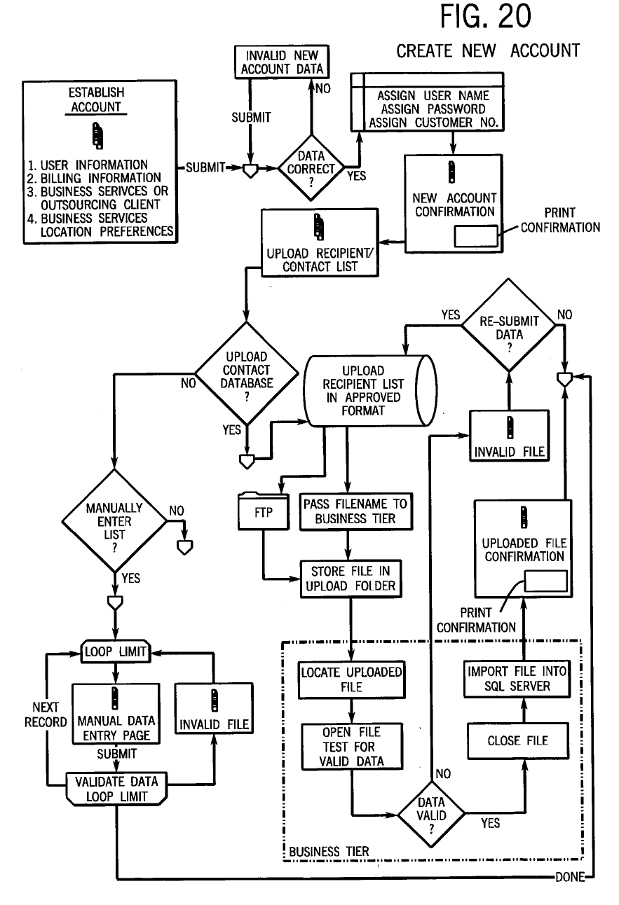

FIG. 20 is a flow diagram showing how a new account is created according to one embodiment of the invention. To establish an account, several types of information are submitted including for example user information, billing information, selection of business services client and/or an outsourcing client (i.e., whether the provider has a regular presence on the premises) and business services location preference. Once the input data has been verified, a user name, password and customer number is assigned. The recipient and contact lists are uploaded, with the contact database updated and the user file stored in the recipient list. Upon validation of the user file, the file is imported into the system.

Existing customers provide their username and password to access the available services. If an incorrect username or password is supplied, then an Invalid Data Page is displayed, asking the user to enter in the correct information. In one embodiment of the invention, after three unsuccessful attempts, the user account is locked out for 24 hours or until they call the system provider. Upon successful login, a welcoming page and a list of available services is displayed to the user. Users who cannot remember their password have a place on the login screen to enter their e-mail address so that they can request an e-mail of their password. Users who request their password will have their e-mail address and user name validated before sending the password by e-mail.

In one particular embodiment of the invention, there are two account creation processes depending on the type of customer. When an outsourcing customer creates a new account, the customer must provide an authorization number to create the account. Upon entering the authorization number, customer information, and billing information, the data is validated and then processed for creation. Upon successful submission of the required data, the user is presented with a confirmation page, which is printable in one embodiment of the invention. The customer will receive an e-mail with the same confirmation information as well as the new user name and password. If during the account creation process, any data entered is invalid, it will be presented on an invalid data page showing what data needs correction. Instead of the above process, it is also possible that the provider will initially determine who shall serve as the initial administrator, who could then prepare the proper account information. Alternatively, it is possible that this particular process could be bypassed, in which case the provider will first create the account.

When a business services customer creates a new account, the customer does not need to enter an authorization number to create the account. Full account status will be granted upon a qualified administrative operator reviewing the account information. When a qualified administrative operator grants the account full status, an e-mail will be automatically sent to the customer that will confirm the account information as well as include the user name, password, and authorization number. Upon entering the customer information and billing information, the data is validated and then processed for creation. Upon successful submission of the required data, the user is presented with a confirmation page, which is printable according to one embodiment of the invention. The customer will receive an e-mail with the same confirmation information as well as their new user name, password, and an authorization number. If during the account creation process, any data entered is invalid, it will be presented on an invalid data page showing what data needs correction. Upon successful submission of account information, the user will be able to login and use one business service prior to receiving full account status. After entering their authorization number on the next login, the customer will be granted full use of all available business services.

Existing customers can modify existing account information by choosing “Modify Account” from the Services Menu after logging on. Customers cannot change their user ID, password, or account number. Customers can change other pertinent information and billing information. Data is validated prior to saving and if any data is invalid then an Invalid Data Page is displayed to the customer so they can change the invalid information.

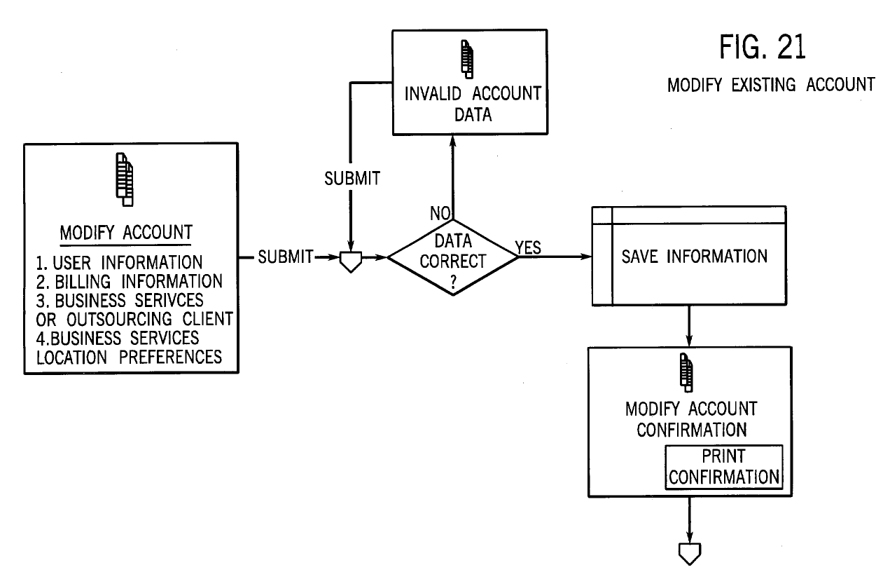

FIG. 21 is a flow diagram showing one implementation of how existing account information can be modified according to one embodiment of the invention. The existing user can enter updated information including for example user information, billing information, selection of business services client or an outsourcing client, and business services location preference. Once the input data has been verified, the updated information is saved.

Account Creation and Maintenance

Online Help. Users may have different types of online help available to them throughout the web site. For example, each field on each web page may have the capacity to display pop-up tool-tips. Additionally, a hotlink entitled “Online Help” may be provided. This hotlink activates a web-based chat client in a new browser window, allowing the user to “chat” directly with a tech support person about their needs. The chat session is private between the customer and the Service Center they have listed as their primary service provider. If for some reason the operator at the Service Center does not respond within a set period of time, then an auto-response message will be displayed to the customer.

The system may also allow the user to click on a User's Guide hotlink on each page that will open an alternate browser and display information about the web page that they are on. The User's Guide will also provide specific information about the services provided, as well as information about filling in the specific Job Request Forms. User's Guides can be specific to the Service Center and may vary between each Service Center based on the available services.

Usage Tracking. Tracking features may be integrated into the system that will help track which pages are accessed, how often, and by whom. The tracking capabilities are built into the system to track username, entry and exit time from the page or time on page.

Customer Surveys. Users may have the ability to fill out a Voice of the Customer Survey indicating their level of satisfaction with the services provided. In one embodiment of the invention, this feature is only available to existing customers who receive an invitation by e-mail and will not show up on the website as a hotlink. Users who receive an e-mail invitation must click on the hotlink in the e-mail or copy it into their browser to access the survey. Before filling in the survey, the user must provide the authorization number provided in the e-mail to begin filling out the survey. The authorization number provides the secure login for the survey. Users may have the ability both to provide comments about the services in general or provide incident-oriented complaints or comments which are directed to one particular task that has been performed by the provider. System administrators have the ability to run reports based on the survey results or export the data to a spreadsheet to create the appropriate charts and graphs.

Different types of surveys can be distributed at different times and to varying customers. For example, Voice of Customer surveys could be sent to 100% of a print Service Center's customers on a bi-annual basis in the spring and the fall. Alternatively or in addition to the Voice of Customer Surveys, Moment of Time surveys could be sent to 100% of a print Service Center's customers on a bi-annual basis in the spring and the fall. Moment In Time surveys could be sent to each customer based on the print Service Center, the service used, and the number of the job request. For example, every tenth customer to submit a job request for a specific service at a specific print Service Center could receive a Moment In Time survey. Additionally, any particular customer is given the ability to report a defect or complaint at any time without having to wait for a particular type of survey.

Once customers have successfully logged into the secure portion of the system, they can access the business service(s) by choosing from a list on a portion of the page. Listed below is a description of representative examples of basic business services.

Print/Copy/Bindery Services.

Customers choosing Print/Copy/Bindery services are presented with a Job Request Form they can fill out to request the specific print/copy/bindery services they require. Customers are also able to specify if the job is to be picked up or if they are uploading the documents. Customers can also upload graphics files required for the print/copy/bindery jobs. Distribution lists can be specified at the time the job is created through several methods, for example selected from the group consisting of (1) Using an existing distribution list that has been previously uploaded; (2) Manually entering distribution list records one by one; (3) Uploading a new distribution list, which can be used separately or merged with an existing one; and (4) Sending an electronic file in a compatible format to be used with the document.

The Job Request Form allows the customer to choose the specific tasks and determine the specifications the particular job requires. In addition to defining the job through specific fields, the customer can enter special handling instructions, required completion date and time and other instructions as necessary. In one embodiment of the invention, the customer will have to print a copy of the Job Request Form after filling it out, as a Job Ticket is required at time of pickup. Job tickets include a tracking number bar-coded on it for tracking purposes. After submitting the Job Request Form, the user is presented with an on-screen confirmation. A confirmation will also be e-mailed to the customer.

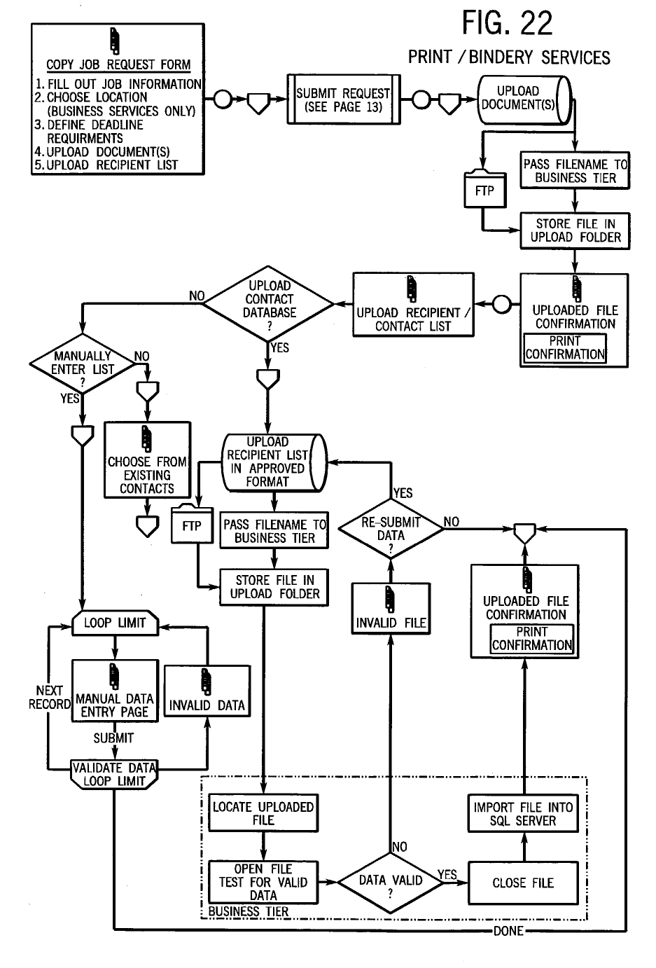

FIG. 22 is a flow diagram showing how print/bindery services are processed according to one embodiment of the invention. To request a job, several types of information are submitted including for example choose location (business services only), define deadline requirements, upload documents, and upload recipient list. The recipient and contact lists are uploaded, with the contact database updated and the user file stored in the recipient list. Upon validation of the user file, the file is imported into the system.

Mail Services.

Customers choosing Mail Services are presented with a Job Request Form. The customer is able to specify if the job is to be picked up or if the customer is uploading the documents. Distribution lists can be specified at the time the job is created through various methods, for example selected from the group consisting of (1) Using an existing distribution list that has been previously uploaded; (2) Manually entering distribution list records one by one; (3) Uploading a new distribution list, which can be used separately or merged with an existing one; and (4) Sending an electronic file in a compatible format to be used with the document.

The Job Request Form allows the customer to choose the specific tasks and determine the specifications the job requires. In addition to defining the job through specific fields, customers can enter special handling instructions, required completion date and time and other instructions as necessary. After filling out the Job Request Form, the customer prints a copy of it on their local printer as a Job Ticket is required at time of pickup in one embodiment of the invention. Job tickets include a tracking number bar-coded on it for tracking purposes. After submitting the Job Request Form, the user is presented with an on-screen confirmation. A confirmation will also be e-mailed to the customer.

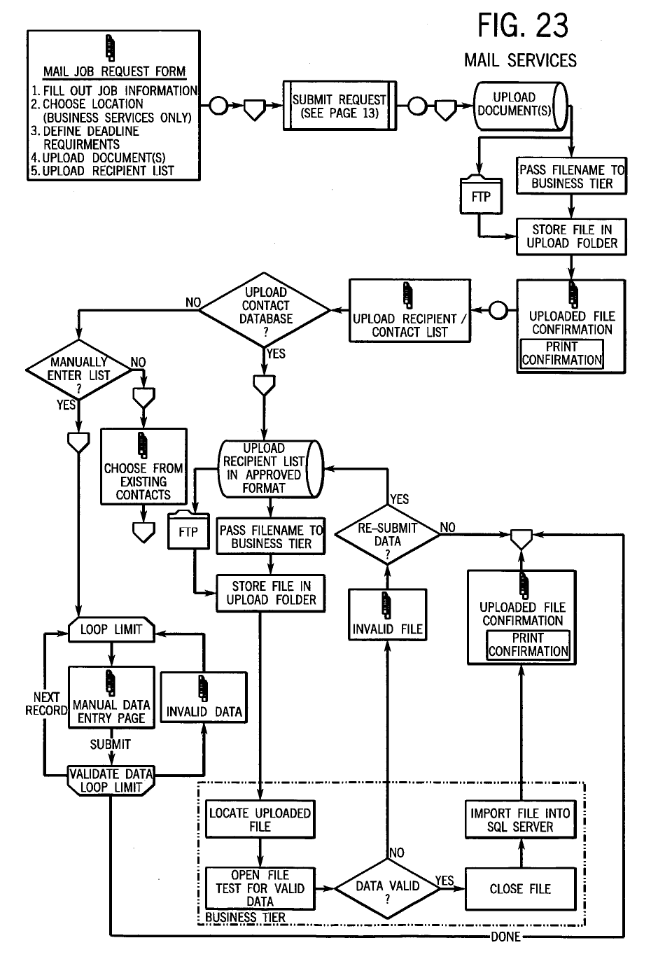

FIG. 23 is a flow diagram showing how mail services are processed according to one embodiment of the invention. To request a job, several types of information are submitted including for example choose location (business services only), define deadline requirements, upload documents, and upload recipient list. The recipient and contact lists are uploaded, with the contact database updated and the user file stored in the recipient list. Upon validation of the user file, the file is imported into the system.

Facsimile Services.

Customers requesting facsimile services are also presented with a Job Request Form. The customer is able to specify if the job is to be picked up or if they are uploading the documents. Distribution lists can be specified at the time the job is created through different methods, for example selected from the group consisting of (1) Using an existing distribution list that has been previously uploaded; (2) Manually entering distribution list records one by one; (3) Uploading a new distribution list, which can be used separately or merged with an existing list; and (4) Sending an electronic file in a compatible format to be used with the document.

The Job Request Form allows the customer to choose the specific tasks and determine the job specifications their job requires. In addition to defining the job through specific fields, customers can enter special handling instructions, required completion date and time and other instructions as necessary. After filling out the Job Request Form, the customer prints a copy of it on their local printer, as a Job Ticket is required at time of pickup in one embodiment of the invention. Job tickets include a tracking number bar-coded on it for tracking purposes. After submitting the Job Request Form, the user is presented with an on-screen confirmation. A confirmation is also e-mailed to the customer.

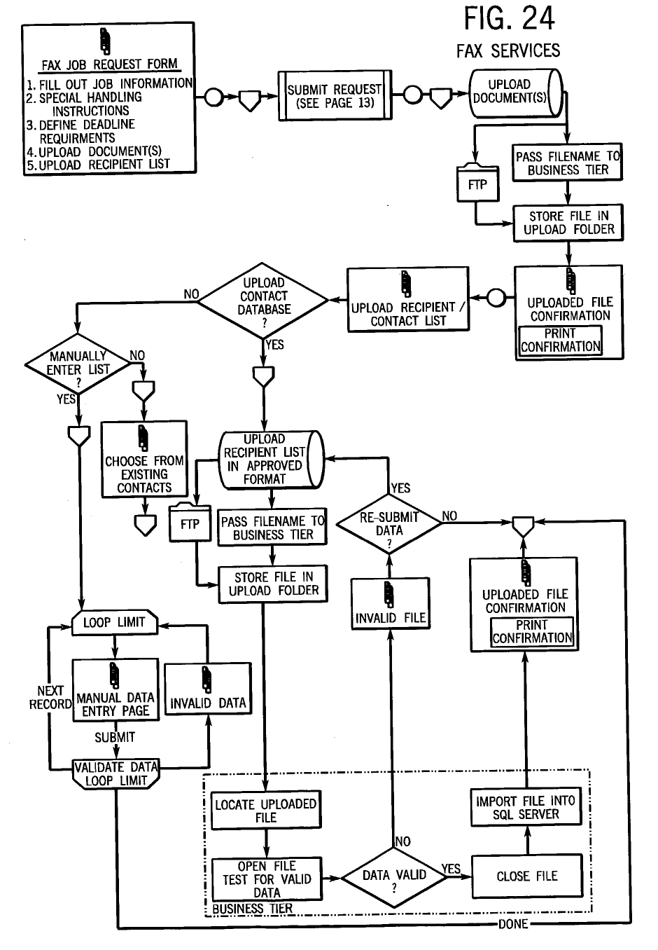

FIG. 24 is a flow diagram showing how facsimile services are processed according to one embodiment of the invention. To request a job, several types of information are submitted including for example special handling instructions, define deadline requirements, upload documents, and upload recipient list. The recipient and contact lists are uploaded, with the contact database updated and the user file stored in the recipient list. Upon validation of the user file, the file is imported into the system.

Courier Services.

Non-Local Courier Services. Customers choosing Courier services are presented with a Job Request Form. In one embodiment of the invention, the user has the option to choose a courier and fill out their shipping request or fill out their shipping request and have the system return a list of couriers, courier services, and prices from which to choose. After submitting the Job Request Form, the user is presented with an on-screen confirmation. Shipping tickets will have a tracking number bar-coded on it for tracking purposes. In a preferred embodiment of the invention, the shipping tickets are designed in a manner to be acceptable and usable by FedEx, UPS, and other non-local couriers. A sample shipping ticket is shown in FIG. 7. If requested by the user, a confirmation can be e-mailed to the customer.

Another option that may be available to the user is entitled the “Rate Shopping.” This function enables the customer to enter generic shipping information about the cargo, where it is to be shipped, and when it needs to arrive at the destination. The system will process that information and return back to the user the couriers supported by the application and the pricing. Both the Service Center and any designated outside service (i.e. courier service, etc.) are immediately notified of the transaction for pick-up. This “on demand” feature may be used with any of the services offered by the provider (copy services, mail services, etc.) in a seamless manner. The Service Center user will be able to scan the bar code on the printed job ticket to pull up the shipping details for that job. Service center staff will need to perform quality inspection of the package and mark that package in the system as reviewed.

A variety of different couriers may be used in this application. Different couriers have different services and functions to service the customer's needs. For example, United Parcel Service (UPS), Atlanta, Ga., has an online toolset that is customizable to suit the needs of the customer. Available tools include:

1. UPS Tracking—UPS tracking enables customers to track their shipments right from an e-commerce site using the company's own reference or order number.

2. UPS Signature Tracking—UPS Signature Tracking allows a customer to track a package, while also providing valuable Proof of Delivery information, including a digitized signature and delivery status.

3. UPS Rates & Services Selection—UPS Rates & Services Selection allows online customers to compare, price, and select the UPS shipping service that best fits their needs and budget.

4. UPS Time in Transit—UPS Time in Transit enables customers to compare the speed of different UPS delivery services, such as UPS Ground, Next Day Air®, and 2^{nd} Day Air®.

5. UPS Address Validation—UPS Address Validation reduces shipping and billing address errors by ensuring that customer-entered shipping addresses are correct at the time of order.

6. UPS Shipping—UPS Shipping enables UPS Web-based shipping to the customer desktop.

Other tools may be incorporated as well. UPS tools are customizable to enable special pricing, printing waybills, and generating tracking numbers and will enable the site to perform to the level of automation desired by the provider.

Another courier service, FedEx Corporation, Memphis, Tenn., has available a program entitled FedEx® Ship Manager API™. This program integrates FedEx Express services with the online environment via FedEx Ship Manager API (Application Programming Interface) software. FedEx Ship Manager API allows one to customize applications according to shipping needs and eliminate redundant programming. FedEx® Ship Manager API lets one connect to FedEx IT systems via the Internet, generate shipping labels, and track packages in real time.

There are different potential options for linking the provider's system to the respective courier's interface. A first option comprises an indirect link via the courier's API. Using this option, the data regarding the package is immediately uploaded upon entry to the specified courier as well as the provider's database. Customers are able to print out a waybill from their desktop and attach it to the package. All of this will be done from the provider's web application. The customer does not need to go to a courier's website (such as UPS, FedEx, etc.) to perform this action.

For FedEx, required data entered by the user and a Universal Transaction Identifier (UTI) must be concatenated into a single data stream for transmission. The UTI is a code indicating how a transaction should be routed to the FedEx Servers. The FedlEx gateway process will recognize the UTI passed with the transaction and route it to the correct FedEx business server. Code is written in the web application to create the necessary data stream in an appropriate manner. Additionally, the Shipping API available from FedEx provides layouts and instructions for waybill creation for the different shipping services. For UPS, required data entered by the user is passed as parameters to the UPS Shipping Online tools. The UPS Shipping tool transmits the data to the UPS backend servers for processing and a UPS waybill will be printed for fixation to the package.

In one possible embodiment of the invention, upon completion of the quality review of the package the Service Center user exports a single shipping ticket or a batch of shipping tickets based on the criteria entered. The file generated as a result of the export is then imported into the courier software (UPS, FedEx) to create waybills to be attached to the appropriate packages. Data from the courier software can be imported into the system to mark that the waybill has been printed and the package is ready to be shipped to its destination. Alternatively, provider personnel pick up the packages and implement quality control at the Service Center. Once the package passes, a button is pushed from the Service Center interface to send the approved package data to the courier backend servers and the appropriate waybills are printed as well.

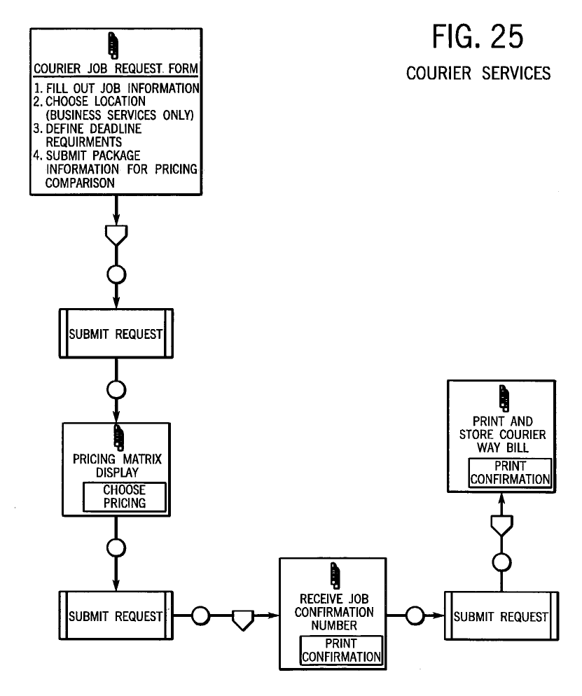

FIG. 25 is a flow diagram showing how a typical job request for courier services is processed according to one embodiment of the invention. To request a job, several types of information are submitted including, for example, choose location (business services only), define deadline requirements, and submit package information for pricing comparison. A pricing matrix is display under which the user chooses the pricing.

Local Courier Services. Customers choosing Local Messenger Services are presented with a Job Request Form. Customers are able to specify where and when the job is to be picked up and delivered. The Job Request Form allows the customer to choose the specific tasks and determine the job specifications their job requires. In addition to defining the job through specific fields, they can enter special handling instructions, required delivery date and time, whether a roundtrip is required along with information as to what is to be brought back on the return trip, and other instructions as necessary. After filling out the Job Request Form, the customer must print a copy of it on their local printer, as a Job Ticket is required at time of pickup according to one embodiment of the invention. Job tickets include a tracking number bar-coded on it for tracking purposes. After submitting the Job Request Form, the user is presented with an onscreen confirmation. A confirmation is also e-mailed to the customer.

Office Supplies. Customers choosing to order office supplies have a direct interface which guides the customers to the appropriate vendor. In this embodiment of the invention and as shown in FIG. 8, the customer actually views and uses the particular vendor's information in the direct interface.

Outsourcing Services

File Services. Outsourcing customers choosing File Services are presented with a Job Request Form. In addition to defining the job through specific fields, customers can enter special instructions such as required completion date and time. After filling out the Job Request Form, the customer have the option to print a copy of it on their local printer or let the-print Service Center print the Job Ticket. Job tickets include a tracking number bar-coded on it for tracking purposes. In the case where the file or record has already been bar-coded, then there is no need for a printout of a job ticket; the existing bar code can just be scanned into the system. After submitting the Job Request Form, the user is presented with an on-screen confirmation. A confirmation will also be e-mailed to the customer.

Hospitality. Outsourcing customers choosing Hospitality Services are presented with a Job Request Form. In addition to defining the job through specific fields, customers can enter special instructions such as required date and time, catering required, and room location size. After filling out the Job Request Form, the customer has the option to print a copy of it on their local printer or let the print Service Center print the Job Ticket. Job tickets have a tracking number bar-coded on it for tracking purposes. After submitting the Job Request Form, the user is presented with an onscreen confirmation. A confirmation will also be e-mailed to the customer.

Office Moves. Outsourcing customers choosing Office Moves Services are presented with a Job Request Form. In addition to defining the job through specific fields, customers can enter special instructions such as required completion date and time. After filling out the Job Request Form, the customer has the option to print a copy of it on their local printer or let the print Service Center print the Job Ticket. Job tickets include a tracking number bar-coded on it for tracking purposes. After submitting the Job Request Form, the user is presented with an on-screen confirmation. A confirmation will also be e-mailed to the customer.

Building Services. Outsourcing customers choosing Building Services are presented with a Job Request Form. In addition to defining the job through specific fields, customers can enter special instructions such as required completion date and time. After filling out the Job Request Form, the customer has the option to print a copy of it on their local printer or let the print Service Center print the Job Ticket. Job tickets have a tracking number bar-coded on it for tracking purposes. After submitting the Job Request Form, the user is presented with an on-screen confirmation. A confirmation will also be e-mailed to the customer.

In addition to the above, other outsourcing services besides Office Moves, Building Services and File Services may also be supplied by the provider. For example, the customer could also request Reception Services for a specific date and location. Additionally, the provider could also provide the “virtual tracking” of individuals who visit a particular site. For example, the first time that an individual visits the site, the individual's identification could be scanned into a database. The location of the individual can thereafter be tracked whenever he visits the site in the future. The precise outsourcing services to be provided can therefore vary depending upon the provider's capabilities and the customers' needs.

Administrative Services

The Administrative Services portion of the present invention may be centrally located at the provider's headquarters and can encompass the server administration and maintenance for the Structured Query Language (SQL) Server, Internet information server and integration of business rules to insure a safe transaction based application. Additional features may be integration with the web interface and print shop interfaces, Administrative Interface, and chat room based Help Desk functionality. Security may be implemented at a variety of levels.

A variety of server types may be installed and configured for operation with the present invention. For example, a SQL Server 2000 Standard Edition may be installed and configured on a hardware compliant server at the provider's headquarters or hosting service. The SQL server operating system may be Windows 2000, Windows XP or a Linux-based or Unix-based system, and the Internet Information Server operating system may be a Windows 2000 Advanced Server or other type of server. The database may be created on the SQL Server, consisting of the appropriate tables, indexes, constraints, views, triggers, and stored procedures required to support the data needs of the Web-based application, the Service center Interface, and the Administrative Interface. An acceptable Maintenance Plan may also be implemented to maintain the server and its databases in optimum condition.

An Internet information server is an integrated part of the Windows 2000 Advanced Server. It is installed at the time the operating system is installed. This server provides the support services for the website, including serving Active Server Pages (ASP) to the customer's web-based client or browser. Configuration of the server is necessary prior to deployment of the web-based application.

A Microsoft Transaction Server (MTS) is an integrated part of Windows 2000 Advanced Server and is entitled COM+. It is installed at the time the operating system is installed. The MTS provides the transaction processing features necessary to insure that data passed from the customer to the data store (database) is successfully saved. The MTS also provides the necessary connection pooling to optimize access to SQL Server by a large number of clients. The MTS provides a repository for the business rules in the form of packages for Dynamic Link Library (DLL).

Integrating the browser based web site functionality with the database requires the construction of one or more DLL modules to provide the functionality for data processing between the client (browser) and the data store (database). The DLLs encompass data requests, data validation, data passed from the client to the server for processing, data retrieval and forwarding from the server to the client, and some data manipulation. The DLLs also act as the keeper of business rules established to maintain data integrity.

Integrating the Service Center functionality with the database requires the construction of one or more DLL modules to provide the functionality for data processing between the client and the data store (database). The DLLs encompass data requests, data validation, data passed from the client to the server for processing, data retrieval and forwarding from the server to the client, and some data manipulation. The DLLs also act as the keeper of business rules established to maintain data integrity.

The Service Center Interface provides each print shop with the necessary functionality to view incoming job requests as well as outstanding job requests. Job queues may be sortable by any column in ascending or descending order. When a customer submits a job, the SQL Server triggers a stored procedure to automatically update job information for each Service Center. Each Service Center “polls” the job information table for their respective jobs on a regular basis and updates the active job queue at the Service Center. The Service Center also has the ability to “re-direct” particular jobs (such as copying jobs, building services, etc.) to the appropriate third parties as necessary. Jobs that require pickup or delivery are noted in the pickup and drop-off queues so the individual Service Center can schedule the pickup or dropoff. Job queues display necessary information so that jobs can be reviewed for file uploads, distribution lists, and quality purposes. In addition to the job posting, each Service Center may be able to upload the documents and associated mailing/distribution lists for each job that requires one.

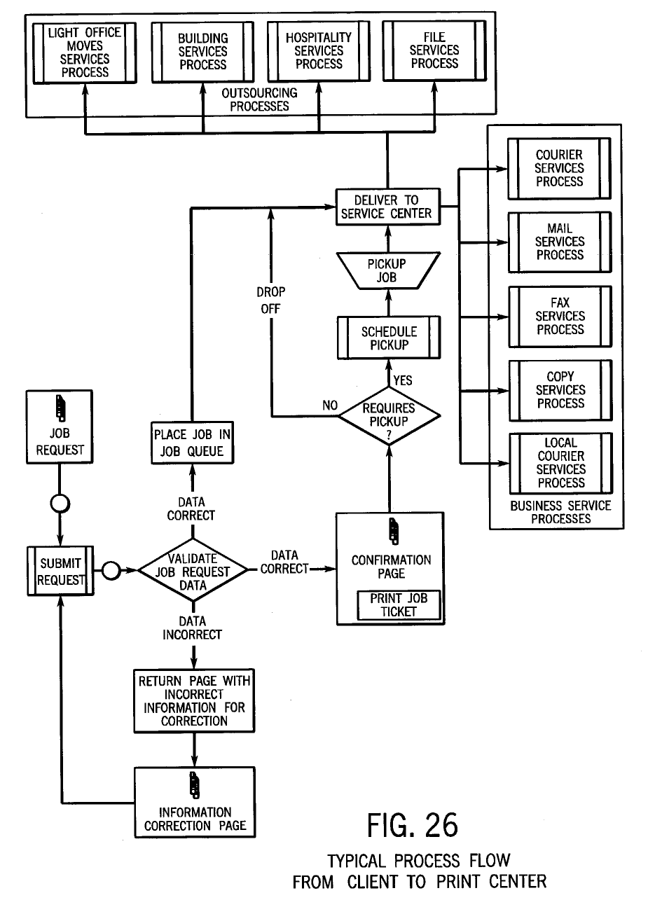

FIG. 26 is a flow diagram showing how a typical job request is routed from a customer employee to a central Service Center according to one embodiment of the invention. FIG. 22 is a flow diagram showing how print/bindery services are processed according to one embodiment of the invention. Upon validation of the job request, the job is placed in a job queue and processed.

Once a job is finished, it can be marked as completed. When a job is completed and marked as such, it may be automatically displayed in the drop-off queue if delivery is required. Completed jobs are displayed in the active job queue for a user selectable period of time after which it is transferred to the job history queue. History queues may display pickup, drop-off, and job history information.

The administrative interface is provided to allow application support personnel to maintain and update data as required by the application. The interface includes several features. A general table maintenance form allows application support personnel to select any table, review its data, and submit any changes, additions, or deletions. Data maintenance screens allow application support personnel to update lockup information such as state, zip code, and rate tables. A user guide form allows specific user guide information to be entered into the application. This includes Service Center, services, descriptive information, graphics to be displayed for each descriptive information records, hotlink information, date time stamps, and user ID stamps. A form is also provided that allows specific survey information (such as “Voice Of the Customer” survey information) to be entered into the application. A customer maintenance form allows application support personnel to validate new customers, remove inactive customers, add or block customers, and modify customer information. Other features which may also be viewed and accessed include the a listing and details of defects that have been reported, the journalization of cost savings, notes on a particular job, and others. Certain preferences that affect the application as a whole can be set using a Preferences form. Some of the preference settings may include: Time elapsed from last transaction before a customer is deactivated by the system, Authorization Code prefix, body, and suffix information.

The ability to import rate schedules for Courier Services allows provider personnel from time to time to update the Courier Service Pricing Matrix data. Those courier services that only provide printed rate schedules can have their data either manually entered or scanned in Optical Character Recognition (OCR) for import. This data is best imported using a SQL Server Data Transformation Services and likely does not have its own interface.

Other features, such as an online chat feature, may also be implemented. To provide Online Chat services, a chat server may be installed and configured. In one embodiment, this chat server is a Microsoft® Internet Information Server (IIS Server). The chat server is configured to provide an instant messaging service for provider customers who require additional help with filling out job tickets. The instant messaging may be used with the preferred print Service Center for that customer. Each session is separate from others so the print Service Center representative could have several sessions open at that time. In a preferred embodiment of the invention, online chats are performed in “one to one” sessions.

An online users guide may be used to provide specific information about the services provided by the provider, as well as information about filling in the specific job request forms. User guides may be specific to the print Service Center to which a customer does business. For example, users guides may be created from a template specific to the outsourcing client or Service Centers.

In the present invention, security may be implemented on multiple levels. Secure login to the website may typically be the first level of security. Use of Secure Socket Layer/Transport Layer Security (SSL/TLS) protocol provides for secure two-way communications between the client and the web server. SSL/TLS technology does this by providing privacy and integrity of the Internet Protocol (IP) packets over the Internet, ensuring secure two-way communication between the client and the web-server. Basic authentication may be implemented at the browser level and supports multiple browsers. Certificate verification is an option, which can also be implemented to provide verification of the user.

IIS Server security is maintained by web access permissions supplied through Windows 2000 security accounts. MTS (COM+) components provide isolation between the layers of the application and provides security authentication for the business layer through role checking. A Windows 2000 advanced server provides for specific accounts to maintain security on the server and on the Internet Information Server. An SQL Server provides secure login and authentication for access to the data to the business services components.

While several embodiments have been shown and described in this application, it is understood that changes and modifications can be made to the invention without departing from the invention's broader aspects. Therefore, the present invention is not limited to the described and illustrated embodiments, but only by the scope and spirit of the independent and dependent claims.

1. A method of providing services to a customer through a single source comprising:
determining the status of the user;
providing employees of the customer the ability to order services from
a plurality of end providers;
transmitting order information through a network to an intermediate provider;
processing the order information;
providing management of the customer with access to information concerning orders; and
providing management of the intermediate provider with access to information concerning orders;
such that both the intermediate provider and the customer management have access to information regarding the intermediate provider services and the customer orders.

2. The method of claim 1 wherein the services are selected from a group consisting of copying, printing, binding, mail, facsimile, courier, messenger, office supply, office moving, hospitality, facilities, visitor tracking, travel, and record maintenance.

3. The method of claim 1 wherein the network is a local area network.

4. The method of claim 1 wherein the network is a wide area network.

5. The method of claim 4 wherein the wide area network is the Internet.

6. The method of claim 1 further wherein employees of the customer are provided with the ability to track orders.

7. The method of claim 1 further wherein employees of the customer are provided with the ability to provide feedback.

8. The method of claim 7 wherein the feedback is a customer survey.

9. The method of claim 1 further wherein employees of the customer are provided with cost estimates on the services.

10. The method of claim 1 wherein the information concerning orders includes frequency of orders.

11. The method of claim 1 wherein the information concerning orders includes customer employee satisfaction, on-time productivity, and employee productivity.

12. The method of claim 1 wherein the information concerning orders includes costs.

13. The method of claim 1 further wherein employees of the intermediate provider have the ability to enter data.

14. The method of claim 1 further wherein management of the intermediate provider has the ability to enter data.

15. The method of claim 14 wherein the data is selected from the group consisting of whether individual orders have been completed, the reasons for delays, the performance of the employees of the provider, feedback concerning the services that are being provided and additional comments that may be necessary.

16. The method of claim 1 further wherein the management of the customer can access a report management system.

17. The method of claim 16 wherein the report management system displays information from the group consisting of the type of services that have been ordered, the date and time which the services were ordered, a description of the services, the status of the order and other information.

18. The method of claim 1 further wherein the management of the customer can monitor the quality of the services provided.

19. The method of claim 1 further wherein management of the customer is provided with the ability to set cost containment parameters.

20. The method of claim 19 wherein the cost containment parameters include employee spending limits.

21. The method of claim 19 wherein the cost containment parameters include a dollar figure beyond which individual employees cannot exceed.

22. The method of claim 19 wherein the cost containment parameters include the ability to suspend certain types of ordering for various services.

23. The method of claim 22 wherein the ability to suspend certain types of ordering for various services is during specified time periods.

24. The method of claim 19 wherein the cost containment parameters include the ability to enable certain types of ordering for various services.

25. The method of claim 1 further wherein management of the customer is provided with an exception report when cost containment figures are exceeded.

26. The method of claim 25 further wherein the exception report provides information selected from the group consisting of whether an individual employee of the customer is approaching a budgetary limit, whether an individual employee of the customer is past a budgetary limit, whether an individual employee of the customer has generated an excessive number of “exception reports” during a specific time frame and whether a user is ordering a service of which the management desires to be made aware.

27. The method of claim 25 further wherein the exception reports are generated on a reoccurring basis.

28. The method of claim 25 further wherein management of the customer is provided with the ability to access the system controls for a particular user.

29. The method of claim 25 further wherein management of the customer is provided with the ability to view the details of a particular transaction from the exception report.

30. The method of claim 25 further wherein the exception report provides management of the customer with the ability to observe real time, onscreen reports about the services that are being provided.

31. The method of claim 25 further wherein the exception report processes data to provide graphs regarding the services.

32. The method of claim 25 further wherein the exception report processes data to provide analysis data regarding the services.

33. The method of claim 1 further wherein management of the customer is provided with instant access to information regarding different characteristics of individual orders.

34. The method of claim 1 further wherein employees of the customer can print ordering documentation.

35. The method of claim 34 wherein ordering documentation is selected from the group consisting of job request tickets, shipping labels, and confirmations.

36. The method of claim 1 further wherein the services available to customers varies depending upon whether the particular customer is an outsourcing customer or a business service client.

37. A method of providing services to a customer through a single source comprising:
determining the status of the user;
providing employees of the customer with the ability to order multiple services through a single source;
transmitting order information through a network to the source; processing the orders; and
providing management of the customer with an exception report when cost containment figures are exceeded.

38. The method of claim 37 further wherein the exception report provides information selected from the group consisting of orders made by employees of the customer, the type of services that have been ordered, the date and time which the services were ordered, a description of the particular job, the status of the job and other information.

39. The method of claim 37 further wherein the exception report provides information selected from the group consisting of whether an individual employee of the customer is approaching a budgetary limit, whether an individual employee of the customer is past a budgetary limit, whether an individual employee of the customer has generated an excessive number of exception reports during a specific time frame, and whether a user is ordering a service of which the management desires to be made aware.

40. The method of claim 37 further wherein the exception reports are generated on a reoccurring basis.

41. The method of claim 40 further wherein the exception reports are generated on a daily basis.

42. The method of claim 37 further wherein management of the customer is provided with an alert that provides access to the exception reports.

43. The method of claim 37 further wherein management of the customer is provided with the ability to access the system controls for a particular user.

44. The method of claim 37 further wherein management of the customer is provided with the ability to view the details of a particular transaction from the exception report.

45. The method of claim 37 further wherein management of the customer is provided with the ability to approve the details of a particular transaction from the exception report.

46. The method of claim 37 further wherein the exception report provides management of the customer with the ability to observe real time, onscreen reports about the services.

47. The method of claim 37 further wherein the exception report processes data regarding the services.

48. The method of claim 47 further wherein the exception report processes data to provide graphs regarding the services.

49. The method of claim 48 further wherein the exception report processes data to provide analysis data regarding the services.

50. The method of claim 37 further wherein management of the provider is provided with access to information concerning orders.

51. The method of claim 37 wherein the services are selected from a group comprising of copying, printing, binding, mail, facsimile, courier, messenger, office supply, office moving, hospitality, facilities, visitor tracking, travel, and record maintenance.

52. The method of claim 37 wherein the network is a local area network.

53. The method of claim 37 wherein the network is a wide area network.

54. The method of claim 53 wherein the wide area network is the Internet.

55. The method of claim 37 further wherein employees of the customer are provided with the ability to track orders.

56. The method of claim 37 further wherein employees of the customer are provided with the ability to provide feedback.

57. The method of claim 56 further wherein the feedback can be a customer survey.

58. The method of claim 57 further wherein the customer survey is provided to the customer by e-mail.

59. The method of claim 37 further wherein employees of the customer are provided with cost estimates on the services.

60. The method of claim 37 further wherein employees of the provider have the ability to enter data regarding orders.

61. The method of claim 60 wherein the data regarding orders is selected from the group consisting of data regarding whether individual orders have been completed, the reasons for delays and any additional comments that may be necessary.

62. The method of claim 37 further wherein management of the provider has the ability to enter data regarding orders.

63. The method of claim 62 wherein the data regarding orders is selected from the group consisting of data regarding whether individual orders have been completed, the reasons for delays, monitoring the performance of the employees of the provider, feedback from employees of the customer and any additional comments that may be necessary.

64. The method of claim 37 further wherein management of the customer is provided with the ability to set cost containment parameters.

65. The method of claim 37 further wherein management of the customer is provided with instant access to information regarding different characteristics of individual orders.

66. The method of claim 37 further wherein management of the customer is provided with flexible reporting regarding different characteristics of individual orders.

67. The method of claim 37 further wherein employees of the customer can upload file attachments for use with specific jobs.

68. The method of claim 37 further wherein employees of the customer can upload user databases for use with specific jobs.

69. The method of claim 37 further wherein employees of the customer can print ordering documentation.

70. The method of claim 69 wherein ordering documentation is selected from the group consisting of job request tickets, shipping labels, and confirmations.

71. The method of claim 37 further wherein the services available to customers varies depending upon whether the particular customer is an outsourcing customer or a business service client.

72. A method of providing services to a customer through a single source comprising:
determining the status of the user;
providing employees of the customer the ability to order services through a single provider;
transmitting order information through a network to the provider; processing the individual orders;
providing management of the customer with the ability to set cost containment parameters.

73. The method of claim 72 wherein the cost containment parameters include individual employee spending limits.

74. The method of claim 72 wherein the cost containment parameters include a specific dollar figure beyond which individual employees of the customer cannot exceed when ordering services.

75. The method of claim 72 wherein the cost containment parameters include the ability to suspend certain types of ordering for various services.

76. The method of claim 75 wherein the ability to suspend certain types of ordering for various services is during specified time periods.

77. The method of claim 72 wherein the cost containment parameters include the ability to enable certain types of ordering for various services.

78. The method of claim 77 wherein the ability to enable certain types of ordering for various services is during specified time periods.

79. The method of claim 72 wherein the services are selected from a group comprising of copying, printing, binding, mail, facsimile, courier, messenger, office supply, office moving, hospitality, facilities, visitor tracking, travel, and record maintenance.

80. The method of claim 72 wherein the network is a local area network.

81. The method of claim 72 wherein the network is a wide area network.

82. The method of claim 72 further wherein employees of the customer are provided with the ability to track orders or requests.

83. The method of claim 72 further wherein employees of the customer are provided with the ability to provide feedback.

84. The method of claim 83 further wherein the feedback is a customer survey.

85. The method of claim 84 further wherein the customer survey is provided to the customer by e-mail.

86. The method of claim 72 further wherein employees of the customer are provided with cost estimates on certain services.

87. The method of claim 72 further wherein the management of the company is provided with the frequency with which certain services are provided.

88. The method of claim 72 further wherein the management of the company is provided with the customer satisfaction level.

89. The method of claim 72 further wherein the management of the company is provided with the costs associated with the provider services.

90. The method of claim 72 further wherein employees of the provider have the ability to enter data regarding orders.

91. The method of claim 72 further wherein management of the provider has the ability to enter data regarding orders.

92. The method of claim 72 further wherein the manager of the customer can access a report management system.

93. The method of claim 92 further wherein the report management system compiles a report detailing each of the orders made by the employee of the customer.

94. The method of claim 72 further wherein the manager of the customer can monitor the quality of the services provided.

95. The method of claim 94 further wherein the quality of the services provided includes production data.

96. The method of claim 72 further wherein management of the customer is provided with an exception report when cost containment figures are exceeded.

97. The method of claim 94 further wherein the exception report provide information selected from the group consisting of whether an individual employee of the customer is approaching a budgetary limit, whether an individual employee of the customer is past a budgetary limit, whether an individual employee of the customer has generated an excessive number of “exception reports” during a specific time frame, and whether a user is ordering a service of which the management desires to be made aware.

98. The method of claim 97 further wherein the exception reports are generated on a reoccurring basis.

99. The method of claim 97 further wherein management of the customer is provided with an alert that provides access to the exception reports.

100. The method of claim 97 further wherein management of the customer is provided with the ability to view the details of a particular transaction from the exception report.

101. The method of claim 97 further wherein management of the customer is provided with the ability to approve or deny the details of a particular transaction from the exception report.

102. The method of claim 97 further wherein the exception report provides management of the customer with the ability to observe real time, onscreen reports about the services that are being provided.

103. The method of claim 72 further wherein management of the customer is provided with instant access to information regarding different characteristics of individual orders.

104. The method of claim 72 further wherein management of the customer is provided with flexible reporting regarding different characteristics of individual orders.

105. The method of claim 72 further wherein employees of the customer can upload file attachments for use with specific jobs.

106. The method of claim 72 further wherein employees of the customer can upload user databases for use with specific jobs.

107. The method of claim 72 further wherein employees of the customer can print ordering documentation.

108. The method of claim 107 wherein ordering documentation is selected from the group consisting of job request tickets, shipping labels, and confirmations.

109. The method of claim 72 further wherein the services available to customers varies depending upon whether the particular customer is an outsourcing customer or a business service client.
